(19) United States
(12) Patent Application Publication
(10) Pub. No.: US 2011/0249062 A1
(43) Pub. Date: Oct. 13, 2011

(54) INKJET PRINTING APPARATUS AND PRINT POSITION ADJUSTING METHOD

(75) Inventors: Takatoshi Nakano, Yokohama-shi (JP); Kiichiro Takahashi, Yokohama-shi (JP); Minoru Teshigawara, Saitama-shi (JP); Tetsuya Edamura, Inagi-shi (JP); Akiko Maru, Tokyo (JP); Yoshiaki Murayama, Tokyo (JP)

(73) Assignee: CANON KABUSHIKI KAISHA, Tokyo (JP)

(21) Appl. No.: 13/076,671

(22) Filed: Mar. 31, 2011

(30) Foreign Application Priority Data
Apr. 7, 2010 (JP) 2010-088653

(51) Int. Cl. B41J 23/00

(52) U.S. Cl. 347/37

(57) ABSTRACT

An inkjet printing apparatus and a print position correction method are provided which, even if satellites are produced, can evaluate printed position misalignments of main droplets without being influenced by the satellites and correctly perform a print position correction. To this end, when the test patterns are printed, the carriage speed and the head-medium distance are set smaller than those used during normal printing operations so as to keep the influences of the satellites on the printed patterns minimal. From the printed test patterns an amount of print position misalignment is acquired. Before actually executing a normal printing operation, an amount of the print position misalignment corresponding to the carriage speed and the head-medium distance of the actual printing operation is determined based on the amount of misalignment obtained from the test patterns and the print position adjustment is made using the determined amount of the print position misalignment.

### BACKGROUND OF THE INVENTION

1. Field of the Invention

The present invention relates to an inkjet printing apparatus for printing an image on a print medium using an ink ejecting print head and to a method of adjusting print positions in the printing apparatus.

2. Description of the Related Art

The inkjet printing apparatus, which prints an image on a print medium by using a print head having a plurality of printing elements that eject ink in the form of droplets, is capable of forming images with high resolution at high speed and with low noise and therefore has found a wide range of applications. A serial type inkjet printing apparatus in particular, which is relatively small in size and forms an image by repetitively alternating a main scan printing operation of the print head and a print medium conveying operation, can produce color images such as photographs at low cost. Thanks to these advantages, it has become increasingly widespread in recent years. To print images with higher resolution in a reduced time, a variety of development and research efforts are being made on the serial type inkjet printing apparatus, such as increasing the density of printing elements, reducing the size of ink droplets and elongating the print head.

The serial type inkjet printing apparatus, however, has some drawbacks. It has been known that many unwanted print position shifts or misalignments are caused by print head manufacturing errors, mounting errors of the print head on the printing apparatus and errors in speed at which a carriage mounting the print head travels. One such example includes print position misalignments between a forward scan and a backward scan and among a plurality of ink colors. Further, if the print head is tilted, position shifts occur in the direction of printing scan between the front end and the rear end even in the same printing scan and with the same ink color. The amount of the print position misalignments becomes more pronounced as the print head becomes longer.

Such print position misalignments lead to a variety of image impairments, such as emphasized jointing lines (between different printing scans), color unevenness, and variations among different bands during multipass printing. To deal with these problems, the ink jet printing apparatus undergoes pre-operation tests to detect a direction and an amount of such print position misalignments in advance to correct the printing positions by adjusting ejection timings in actual print operation and thereby minimize the positional deviations on the print medium. As increasing efforts are being made particularly to enhance the printing resolution and reduce the ink droplet size in recent years, the allowable range of print position misalignment is becoming smaller calling for corrections of even higher precision.

Under these circumstances, Japanese Patent Laid-Open No. 2007-015260 discloses a technology to correct the print position misalignment between a front end nozzle and a rear end nozzle of a print head with a higher precision than the printing resolution.

Today, with ink droplets continuing to get smaller, it has been observed that the accuracy of correcting the print position misalignments is degraded by the presence of satellites of ink droplets ejected from individual printing elements. The satellites refer to ink droplets which are ejected trailing main droplets and have smaller volume than that of the main droplets so that they land at positions apart from those of the main droplets. Even when such satellites occur, as long as the ejection volume of the print head or the main droplets themselves are sufficiently large as in conventional printing apparatus, the presence of any satellites and their landing positions do not pose any serious problem in determining the print positions of the main droplets. However, as the main droplets become smaller in volume, as observed in recent years, the actual landing positions (print positions) of the main droplets may get wrongly determined under the influence of the size and landing positions of the satellites. Any attempt to correct the print positions based on such an incorrectly determined print position misalignment cannot get them to right or optimal positions. Nor can it resolve the aforementioned image impairments.

### SUMMARY OF THE INVENTION

The present invention has been accomplished to overcome the problems described above. It is therefore an object of this invention to provide an inkjet printing apparatus and a print position correction method both of which, even if satellites are produced, can determine the print position misalignment of the main droplets without being affected by the presence of the satellites and can accurately correct the print positions.

In a first aspect of the present invention, there is provided an inkjet printing apparatus to form an image on a print medium by scanning a print head having an array of printing elements relative to the print medium and ejecting ink from ejection openings of the printing elements onto the print medium to form dots thereon, the inkjet printing apparatus comprising: a unit configured to print a predetermined pattern on the print medium by executing a first printing operation and a second printing operation by a relative scanning of the print head wherein a distance between an ejection opening-formed surface of the print head and the print medium is set at a first print head-to-medium distance and a scan speed of the print head is set at a first scan speed; a unit configured to acquire an amount of print position misalignment between the first printing operation and the second printing operation by examining the predetermined pattern; and a unit configured to print an image on the print medium by executing a first printing operation and a second printing operation according to a correction value obtained from the amount of print position misalignment, wherein a distance between the ejection opening-formed surface of the print head and the print medium is set at a second print head-to-medium distance larger than the first print head-to-medium distance and the scan speed of the print head is set at a second scan speed faster than the first scan speed.

In a second aspect of the present invention, there is provided a print position adjusting method for an inkjet printing apparatus, wherein the inkjet printing apparatus forms an image on a print medium by scanning a print head having an array of printing elements relative to the print medium and ejecting ink from ejection openings of the printing elements onto the print medium to form dots thereon, the print position adjusting method comprising: a step for printing a predetermined pattern on the print medium by executing a first printing operation and a second printing operation by a relative scanning of the print head wherein a distance between an ejection opening-formed surface of the print head and the print medium is set at a first print head-to-medium distance and a scan speed of the print head is set at a first scan speed; a step for acquiring an amount of print position misalignment between the first printing operation and the second printing operation by examining the predetermined pattern; and a step for printing an image on the print medium by executing a first printing operation and a second printing operation according to a correction value obtained from the amount of print position misalignment, wherein a distance between the ejection opening-formed surface of the print head and the print medium is set at a second print head-to-medium distance larger than the first print head-to-medium distance and the scan speed of the print head is set at a second scan speed faster than the first scan speed.

Further features of the present invention will become apparent from the following description of exemplary embodiments (with reference to the attached drawings).

### BRIEF DESCRIPTION OF THE DRAWINGS

FIG. 1 is a perspective view of a main portion of the serial type inkjet printing apparatus applicable to an embodiment of this invention;

FIG. 2 is a perspective view schematically showing a main structure of a printing element board of a print head;

FIG. 3 is a schematic view of the print head as seen from an ejection opening side;

FIG. 4 is a schematic block diagram of a control system in the inkjet printing apparatus used in the embodiment of this invention;

FIGS. 5A and 5B are general dot patterns used to adjust a print position;

FIGS. 6A-6G are cross-sectional views of one printing element showing a process of ink ejection;

FIGS. 7A-7C explain how a carriage scan speed S and a print head-to-medium distance d affect a distance on the print medium between a main droplet and a satellite, x;

FIG. 8 is a graph showing a comparison in the density of a pattern between two different carriage scan speeds;

FIG. 9 is a table showing values of the carriage scan speed and of the print head-to-medium distance for each of different print mediums; and

FIG. 10 is a schematic view of another print head as seen from an ejection opening side.

### DESCRIPTION OF THE EMBODIMENTS

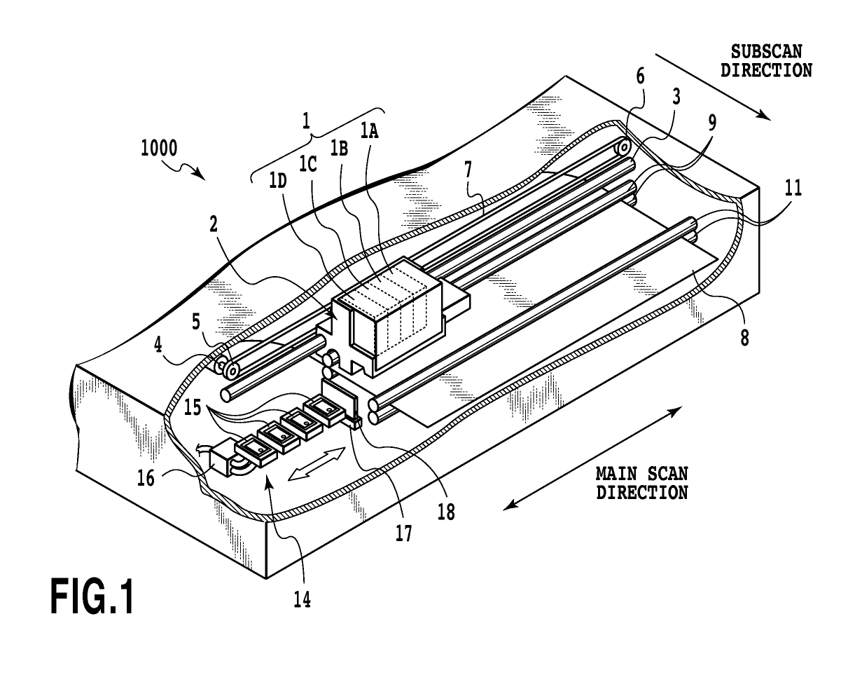

Now, embodiments of this invention will be described in detail by referring to the accompanying drawings. FIG. 1 is a perspective view of a main portion of a serial type inkjet printing apparatus 1000 applicable to an embodiment of this invention. Head cartridges 1A-1D each have an ink tank accommodating a cyan (C), magenta (M), yellow (Y) or black (Bk) ink and a nozzle array to eject the associated ink. They are all replaceably mounted on a carriage 2. The carriage 2 has a connector holder to transmit a drive signal to each head cartridge 1A-1D through a connector. In the following description, the entire head cartridges 1A-1D or any one of them is referred to simply as a print head 1.

The carriage 2 is guided and supported by a guide shaft 3 mounted on an apparatus body and can be moved in a main scan direction by a driving force of the main scan motor 4 being conveyed through a motor pulley 5, a follower pulley 6 and a timing belt 7.

Below the area where the print head 1 can be moved is a conveying area for the print medium 8. In this area the print medium 8 is conveyed stepwise in a subscan direction crossing the main scan direction by the rotation of two pairs of conveying rollers 9, 11. Placed underneath the print medium 8 that is positioned where it can be printed by the print head 1, there is a platen that supports the print medium so that it is held flat with respect to the ejection opening face of the print head 1.

In this construction the printing scan of the print head in the main scan direction and the medium conveying operation in the subscan direction are alternated repetitively to progressively form an image on the print medium 8.

At the end of the scan area of the print head 1 is installed a recovery unit 14 to perform a maintenance operation on the print head 1. The recovery unit 14 includes caps 15 for protecting the ejection opening face of the print head 1, a wiper 18 for wiping clean the ejection opening face of the print head 1 and a suction pump 16 for forcibly drawing ink from the print head 1 and the like. The wiper 18, when not in use, is retracted into a wiper accommodation unit 17.

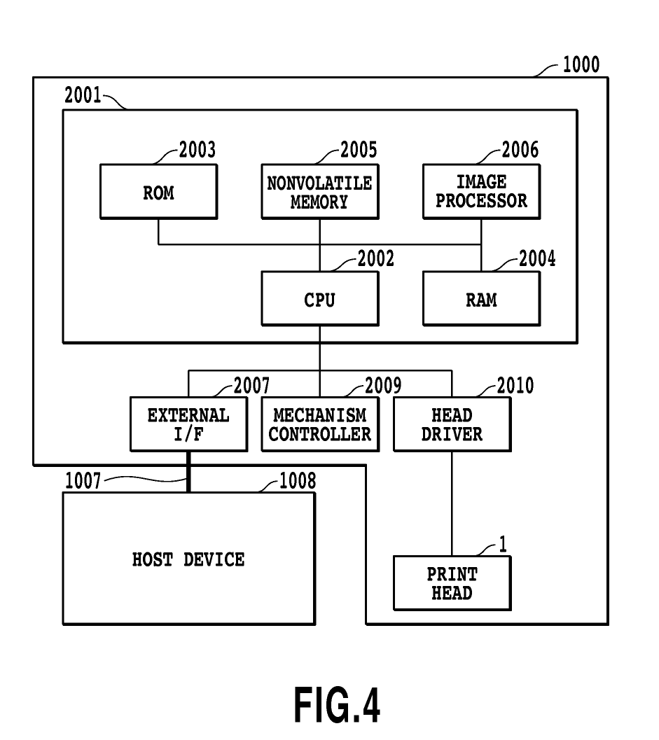

FIG. 4 is a block diagram showing an outline configuration of a control system in the serial type inkjet printing apparatus 1000. A control unit 2001 controls the entire printing apparatus 1000 and has a CPU 2002, a ROM 2003, a RAM 2004, a non-volatile memory 2005 and an image processor 2006. The CPU 2002, according to a program installed in the ROM 2003, executes a variety of operations using the RAM 2004 as a work area. In addition to such a work area, the RAM 2004 also has a data memory area in which to store print job data and image data received from the outside. The ROM 2003 stores a print position adjustment pattern and a correction table as well, both described later. The nonvolatile memory 2005 nonvolatilely stores setting items that can change from time to time, such as the kind of print medium being printed and a print mode, independently of power supply. The image processor 2006 processes image data received for each pixel to generate binary image data to be sent to the print head 1.

A mechanism controller 2009 is a drive unit to make a variety of mechanisms installed in the inkjet printing apparatus 1000 perform their functions. The mechanism controller 2009 comprises, for example, a paper conveying drive unit for the print medium 8 and a carriage drive unit for moving the carriage 2 mounting the print head 1 in the main scan direction. A head driver 2010, according to the print signal received from the control unit 2001, drives the print head 1 to eject ink.

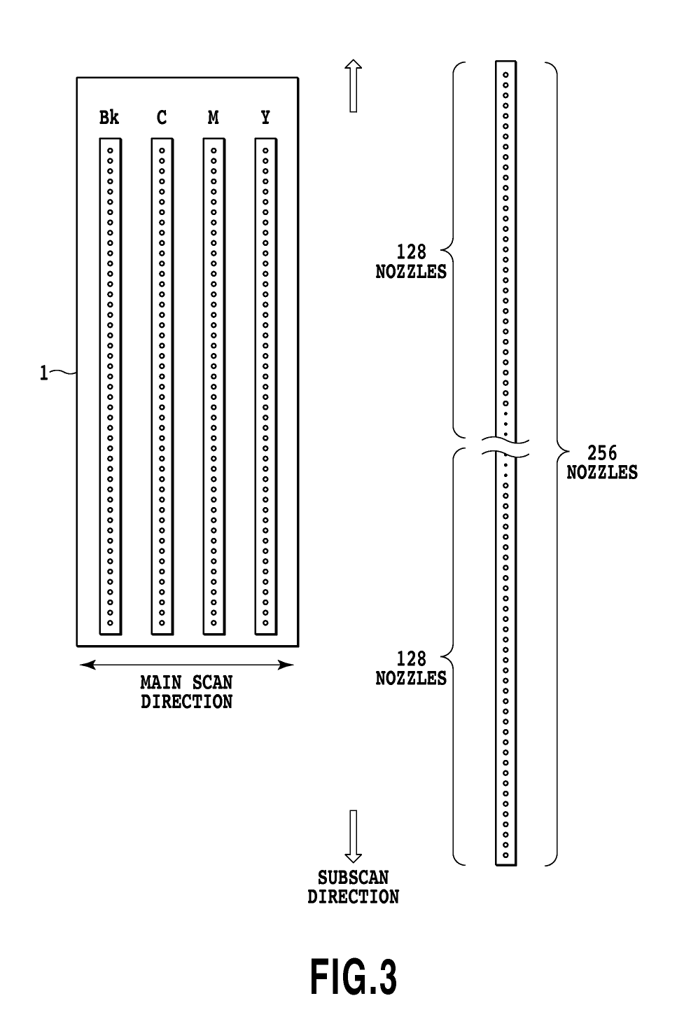

FIG. 3 schematically shows the print head 1 of this invention as seen from the ejection opening side. The print head 1 has 256 ejection openings or nozzles openings arranged at a 600-dpi pitch or at an interval of about 42 μm in the subscan direction to form a nozzle array for one color. There are four such nozzle arrays for black (Bk), cyan (C), magenta (M) and yellow (Y), arranged side by side in the main scan direction. By causing the print head 1 of this construction to eject inks from individual nozzles at a predetermined frequency as it is scanned in the main scan direction, a 600-dpi color image can be printed on a print medium.

When, for example, a multi-pass printing for 2-pass is performed, in one scan, 128 nozzles or one-half of the 256 nozzles on the upstream side in the print medium conveying direction are used to form an image in a certain area and, in another scan, the remaining 128 nozzles or the other half of the 256 nozzles on the downstream side are used to complete the image in that area. So, some provisions need to be made to prevent a misalignment on the print medium between the positions of dots printed by the 128 upstream nozzles and the positions of dots printed by the 128 downstream nozzles. It is also necessary to keep the positions of dots printed by the Bk nozzle array and the positions of dots printed by the CMY nozzle arrays from shifting from each other. Further, some arrangements need to be taken to ensure that the dot positions during the forward scan and the dot positions during the backward scan are aligned. That is, the inkjet printing apparatus requires various dot position adjustments.

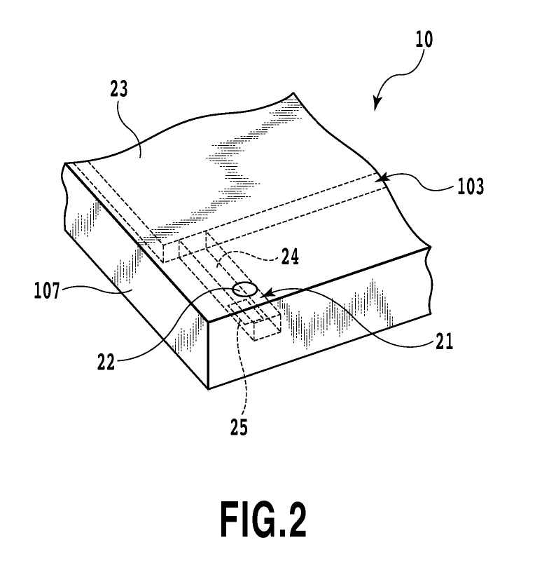

FIG. 2 is a perspective view schematically showing a main structure of a printing element board 10 in the print head 1 of this invention. The printing element board 10 has a heater board 107 formed with an electric circuit to impart an ejection energy to ink according to the print signal and a nozzle member 103 formed with ink paths for introducing ink to individual ejection opening, with these two member 107, 103 bonded together to form the 256 nozzles. Ink supplied from the ink tank of the head cartridge and stored in a common liquid chamber 23 is introduced by a capillary attraction through a plurality of ink paths 24 into individual ejection openings 22. At a position in each of the individual ink paths 24 that opposes each of the ejection openings 22 is installed a heater (electrothermal transducing element) 25 that is applied a voltage pulse according to the print signal. When a voltage pulse is applied to the heater 25, a film boiling occurs in that part of the ink in the path which is in contact with the heater 25, producing a bubble. As the bubble expands, a predetermined amount of ink is ejected as an ink droplet from the ejection opening 22. An ejection opening surface 21 formed with an array of ejection openings 22 is planar, parallelly facing the print medium 8. In this embodiment, the ejection openings 22 are arrayed at a pitch of about 42 μm (600 dpi) in the subscan direction.

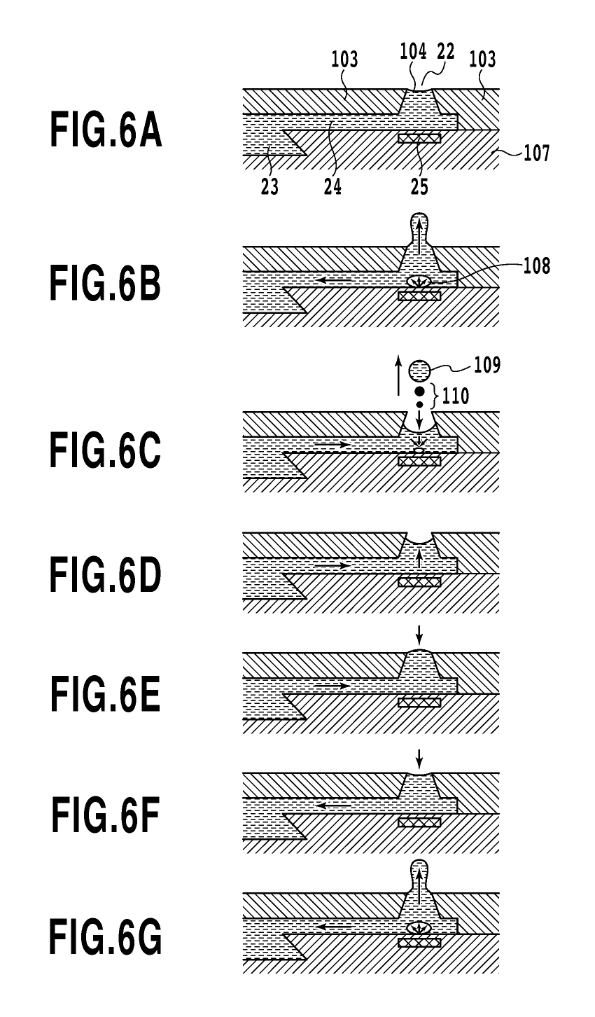

FIGS. 6A-6G are structural cross sections showing one printing element (nozzle) ejecting an ink droplet in a series of steps. FIG. 6A shows the printing element at rest in a stable state. The ink represented by horizontal line segments is drawn from the common liquid chamber 23 up to the ejection opening 22 by capillary attraction. In the ink tank supplying ink to the common liquid chamber 23, there is also a negative pressure that tends to pull back the ink. So, where these two forces balance with each other, the ink stays still, with a concave meniscus 104 formed at the ejection openings 22.

Referring to FIG. 6B, when the print head receives a print signal, it applies a voltage pulse to the heater 25 formed in the heater board 107, rapidly heating the heater 25. This causes that portion of the ink which is in contact with the heater 25 to film-boil to generate a bubble 108. The bubble 108 continues to inflate while the heater 25 is energized, pushing the surrounding ink in the ink path 24 by its expansion force. As a result, a portion of ink near the ejection opening 22 is expelled in the direction of arrow, breaking the meniscus 104. At the same time, a portion of ink close to the common liquid chamber 23 is pushed back towards it.

When, with the ink protruding greatly from the nozzle opening 22 as shown in FIG. 6B, voltage application to the heater 25 is stopped, the bubble 108 shrinks, pulling the ink near the ejection opening back into the ink path as shown in FIG. 6C. At the same time, that portion of ink which has protruded from the ejection opening parts from the ink being pulled into the ink path and then flies away from the ejection opening 22. At this time, the flying ink separates into a main droplet 109 and satellites 110, a group of smaller ink droplets following the main droplet 109.

After the bubble collapsed, the meniscus 104 that was pulled in moves toward the ejection opening 22 again by the capillary attraction, allowing the ink path 24 to be supplied with ink (FIG. 6D).

When it comes near the ejection opening or the initial state, the ink meniscus does not immediately stop because of its inertia and bulges slightly out of the ejection opening (FIG. 6E). But when it bulges to some extent, the meniscus is pulled back into the ejection opening 22 again by the surface tension of the ink and the negative pressure in the tank (FIG. 6F). If no further voltage application is done to the heater 25, the meniscus moves back and forth repetitively due to a tug between the capillary attraction and the negative pressure in the tank between the states of FIG. 65 and FIG. 6F while progressively attenuating until it returns to the static state of FIG. 6A. Then, when a next print signal is supplied, the heater 25 is again energized to produce a bubble in the ink (FIG. 6G).

As described above, only when the meniscus becomes stabilized to some extent following the ejection of one ink droplet and the refilling of the ink path with ink, is the next bubble forming step for ejecting an ink droplet initiated. This ensures that ink droplets of a constant volume can be ejected.

Next, a print position adjustment method to be executed in this embodiment will be explained.

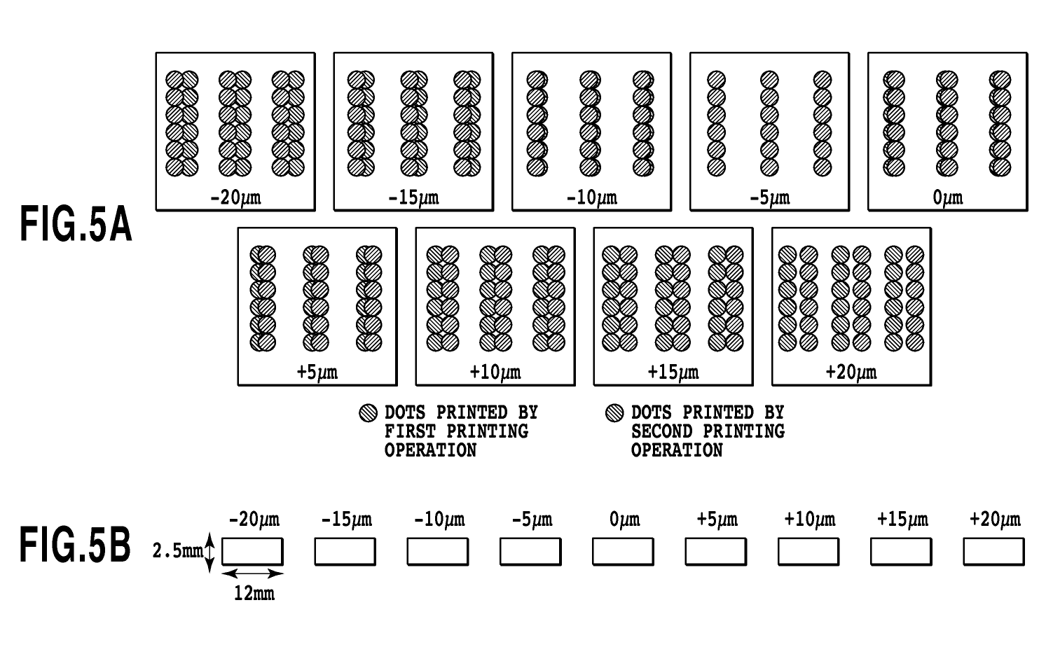

FIGS. 5A and 5B show general dot patterns used to adjust the print positions. FIG. 5A shows arrangements of dots printed by a combination of a first printing operation and a second printing operation to measure misalignments in print position between the first printing operation and the second printing operation. Here, the first printing operation and the second printing operation constitute a two-step printing operation intended to match a print position alignment each other. For example, the first printing operation may be performed by a forward printing scan of a nozzle array and the second printing operation by a backward printing scan of the same nozzle array. It is also possible to perform the first printing operation with a black head and the second printing operation with other color heads. Further, the first printing operation may be done by a front portion of a nozzle array of a long print head and the second printing operation by a rear portion of the nozzle array.

FIG. 5A shows nine dot patterns printed with a combination of the first and the second printing operations by keeping the print position of the first printing operation fixed and changing the print position of the second printing operation by 5 μm in the main scan direction from one two-step printing operation to another for a total of nine times to print the nine dot patterns. Although only three columns of printed dots are shown in each pattern for ease of explanation, each pattern has dots printed according to its own dot arrangement rule throughout its pattern area (2.5 mm high by 12 mm wide). Nine such patterns are shown arranged in line in FIG. 5B.

In a dot pattern printed by shifting the second printing operation −5 μm from the first printing operation, the two groups of dots formed by these two printing operation completely overlap each other. That is, of all the nine patterns, the pattern printed with a −5 μm shift has the least dot-covered area and is therefore detected as being lowest in density by the user's visual check or density sensor. By selecting from among the nine patterns the one with the lowest density as described above, the amount and direction of the misalignment of the second printing operation with respect to the first printing operation can be determined. Then, before an image is actually printed, the second printing operation is set −5 μm from the first printing operation so that the print positions of the two groups of dots can be aligned.

However, referring again to FIG. 6C, the main droplet 109 and the satellites 110 generally have different speeds when ejected, and often land at different positions on a print medium. That is, the satellites may land on blank areas in the patterns of FIG. 5A, increasing the dot-covered area and therefore the density of these patterns. In such a case, if nine patterns are printed as shown in FIGS. 5A and 5B, density differences among these patterns are unlikely to show up, making it difficult to correctly choose a pattern with the lowest density. As a result, a precise amount of misalignment of the second printing operation with respect to the first printing operation cannot be obtained.

It should be noted that the distance between two dots formed on the print medium by the main droplet and the satellite changes according to a scan speed of the print head (i.e., carriage speed) and a distance between the ejection opening face of the print head and the print medium (head-medium distance) as well as the speeds of the droplets. This invention uses this phenomenon to minimize the distance between the two dots formed by the main droplet and the satellite when printing the dot patterns.

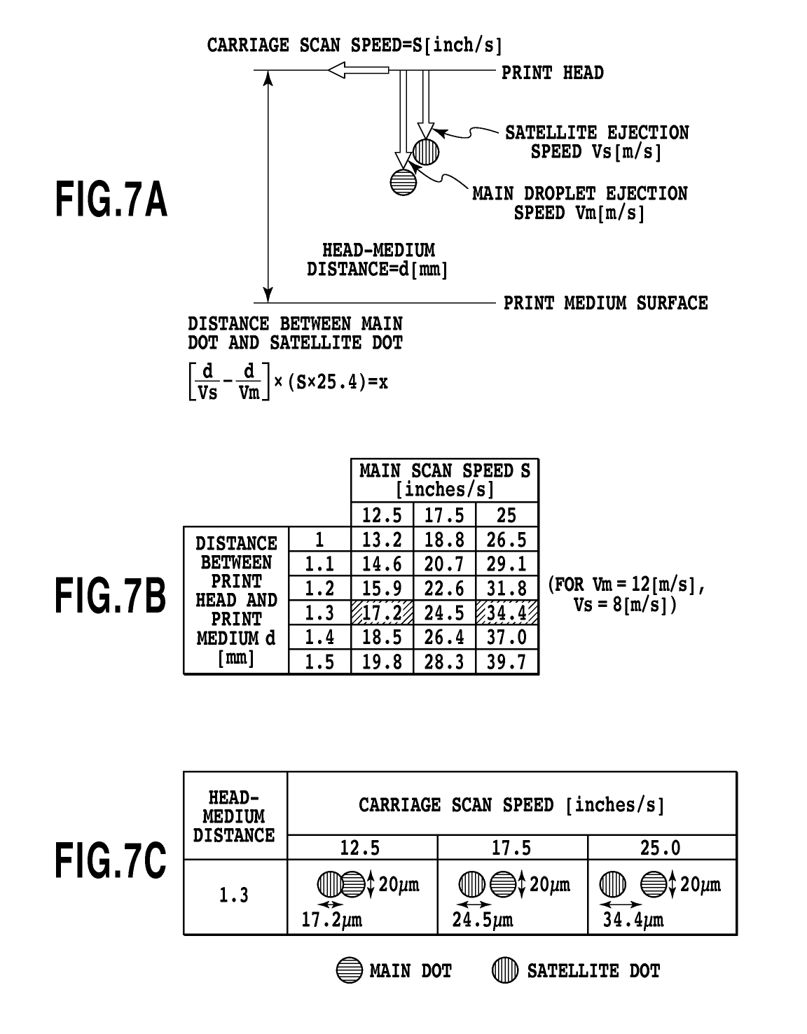

FIGS. 7A-7C explain how the carriage scan speed S and the head-medium distance d affect the distance on the print medium between a main droplet and a satellite, x.

Referring to FIG. 7A if we let a main droplet ejection speed be Vm, a satellite ejection speed Vs, a carriage scan speed S and a head-medium distance d, then the distance x between two dots on the print medium formed by the main droplet and the satellite is expressed as

x=(d/Vs−d/Vm)×S.

FIG. 7B is a table showing the relationship among the three quantities—the carriage scan speed S, the print head-to-medium distance d and the main droplet-satellite distance x. The main droplet-satellite distances x shown in the table are obtained by setting the main droplet ejection speed Vm at 12 m/s, the satellite ejection speed Vs at 8 m/s, the carriage scan speed S at three different values of 12.5 inches/s, 17.5 inches/s and 25 inches/s, and the head-medium distance d at six different values from 1 mm to 1.5 mm. It is seen that the main droplet-satellite distance x increases with the carriage scan speed S and the head-medium distance d.

FIG. 7C schematically shows positional relations between two dots formed by a main droplet and a satellite for three different carriage scan speeds of FIG. 7B with the head-medium distance set at 1.3 mm. Although in an actual ink ejection two or more satellites smaller than a main droplet may be produced to form a plurality of dots, it is assumed here for the sake of simplicity that only one satellite is formed and that the main droplet and the satellite have the same diameter of 20 μm. When the carriage speed is 12.5 inches/s, the distance between the main dot and the satellite dot is 17.2 μm, with two dots partially overlapping. When the carriage speed is 17.5 inches/s, the distance between the main dot and the satellite dot is 24.5 μm, with a gap of 4.5 μm between the two dots. When the carriage speed is 25.0 inches/s, the distance between the main dot and the satellite dot is 34.4 μm, with the two dots completely separate by a far greater gap.

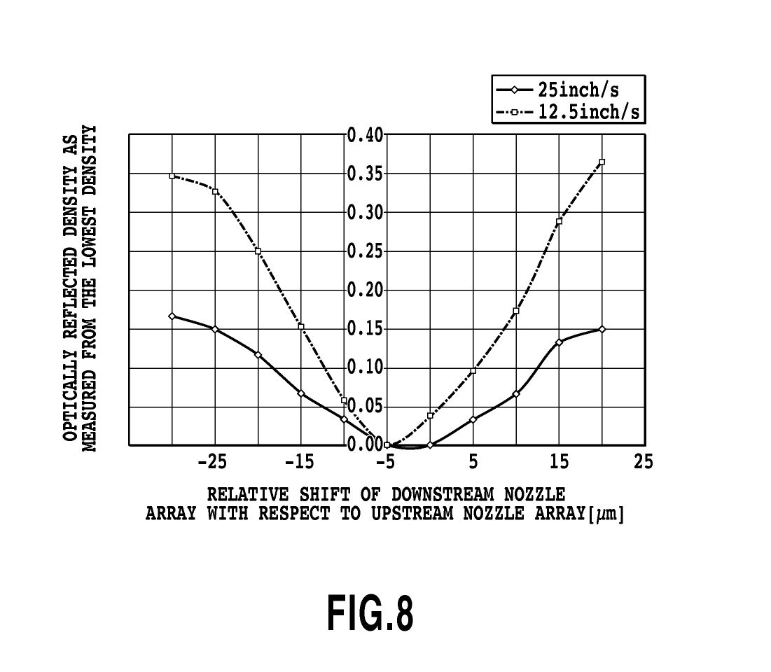

FIG. 8 shows a comparison between a 9-pattern density change at a carriage speed of 25.0 inches/s and a 9-pattern density change at 12.5 inches/s. In the figure, the abscissa represents the amount of misalignment of the second printing operation from the first printing operation (indicated at the bottom of each dot pattern of FIG. 5A) and the ordinate represents a density difference of each of the nine dot patterns as measured from the lowest density among them.

Although the −5 μm misalignment dot pattern has a zero density difference for either of the carriage speeds 25.0 and 12.5 inches/s, the density difference curve of the carriage speed of 25.0 inches/s has smaller density differences from the lowest density than the curve of the 12.5 inches/s, making the selection of a minimum density pattern more difficult. This is due to the fact that since the satellite dot is separate from the main dot, the dot-covered area does not decrease even in the −5 μm misalignment dot pattern of FIG. 5A, in which the main dots formed by the first and the second printing operations completely overlap. This results in the density of this dot pattern failing to fall sufficiently from those of other dot patterns. For the carriage speed of 12.5 inches/s, on the other hand, the two dots (satellite dot and main dot) are note separated, so that the dot-covered area is not so affected. That is, a pattern with the lowest density can easily be chosen from among a plurality of patterns, allowing for the correct determination of the amount of misalignment.

With the above taken into consideration, the printing apparatus of this embodiment, when printing the patterns shown in FIGS. 5A and 5B, sets the carriage scan speed at a slower-than-normal speed of 12.5 inches/s, even if the normal printing is executed at a relatively fast carriage scan speed.

As described with reference to FIG. 7B, the distance between two dots formed by the main droplet and the satellite increases with the head-medium distance. So, in this embodiment, even if the normal printing uses a relatively large head-medium distance, the patterns of FIGS. 5A and 5B are printed with the head-medium distance d set at a smaller-than-normal distance of 1.0 mm.

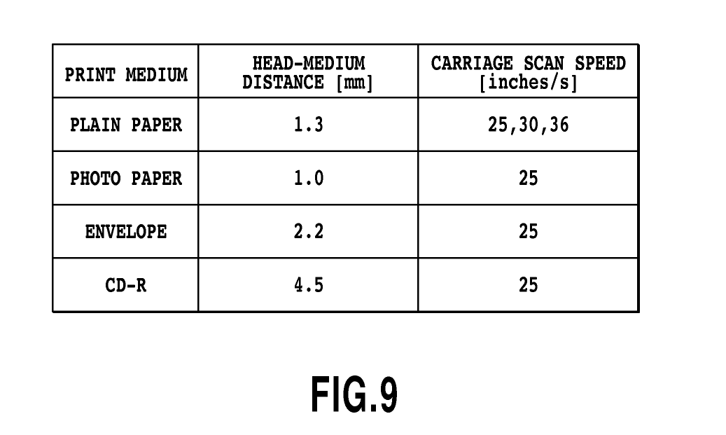

FIG. 9 shows the carriage scan speed and the head-medium distance for each type of a variety of print media when an image is actually printed. In this way, a inkjet printing apparatus can print on a variety of print media and, according to the type of print medium used, the head-medium distance and the carriage scan speed are selected. The head-medium distance can be adjusted by an elevating of guide shaft 3 as changing means of position of the carriage 2.

The head-medium distance is determined such that the ejection opening face of the print head does not come into contact with the print medium, by considering the thickness of the print medium and the medium's tendency to deflect during printing. That is, for photo paper with no deflection problem during printing but of which there is a demand for high quality images, the head-medium distance is set small. For thick print media such as CD-Rs and envelopes, the head-medium distance is set large.

The carriage scan speed is determined according to the use of the printed matter, the ink absorption speed, the output speed required by the user and so on. For plain paper for example, three different carriage scan speeds are provided for a high quality image print mode, a standard print mode and a high speed print mode.

During the normal image output, as described above, the carriage scan speed and the head-medium distance are changed according to the kind of print medium used and the print mode. In any print mode, the print position can be corrected by using the amount of print position misalignment determined as described above. That is, the print position correction involves printing nine patterns of FIGS. 5A and 55 with the carriage speed set to 12.5 inches/s and the head-medium distance to 1.0 mm, selecting a pattern with the lowest density and using the amount of print position misalignment of the selected pattern to perform the print position correction for each mode. In the case of an envelope for example, an equation shown in FIG. 7A is used to calculate what the amount of misalignment that has been obtained for the carriage speed of 12.5 inches/s and the head-medium distance of 1.0 mm will be when the carriage speed and the head-medium distance are set to 25.0 inches/s and 2.2 mm, respectively. Then, based on the calculated result, the print position misalignment can be corrected. As described above, from the amount of misalignment determined by examining the actually printed patterns, optimal amounts of correction can be obtained for all print modes. It is also possible to prepare a table beforehand which assigns the different print modes the amounts of correction calculated from the amount of misalignment determined from the actually printed patterns and then to store the table in the ROM 2003.

As described above, in this embodiment, when the print position adjustment patterns are printed, the carriage speed and the head-medium distance are set to a first scan speed and a first head-medium distance, both smaller than those used during the normal printing, so as to print the patterns that are as free from influences of satellites as possible. By examining these patterns, a highly reliable amount of misalignment little influenced by satellites is obtained. Then, prior to performing an actual printing operation, a correction value that corresponds to the carriage speed and the head-medium distance used in the actual printing, i.e., a second scan speed and a second head-medium distance, is acquired and, based on this correction value, the print position is adjusted. With such a correction procedure, it is possible to produce a stable image free from print position misalignments in any print mode with any kind of print medium.

### OTHER EMBODIMENTS

Although in the above embodiment the serial type inkjet printing apparatus has been described as an example, this invention is also applicable to a full-line type printing apparatus. In the full-line type printing apparatus, the print head, instead of traveling relative to the print medium, is fixed inside the printing apparatus and ejects ink at a predetermined frequency onto the print medium that is being conveyed continuously at a constant speed. In this case, while no print position misalignments occur between the forward scan and the backward scan or between the front and rear portions of one nozzle array, if a plurality of print heads or nozzle arrays are arranged side by side, there is a possibility of print position misalignments occurring between different nozzle arrays. When satellites land on the print medium at positions deviated in a relative scan direction of the print head with respect to the print medium, i.e., in the print medium conveying direction, the similar problem to that of the preceding embodiment will result.

However, even in such a full-line type printing apparatus, reducing the conveyance speed of the print medium and setting the head-medium distance small can shorten the distance between the main dot and the satellite dot to detect a correct amount of misalignments in the same way as described in the preceding embodiment.

While in the preceding embodiment the patterns of FIG. 5A have been used as an example means to detect the amount of print position misalignment, this invention is not limited to this type of patterns. For example, a set of patterns may be used which, when there is no print position misalignment, produces the largest dot-covered area and exhibits the highest density value. Such a pattern set can also produce the similar effect.

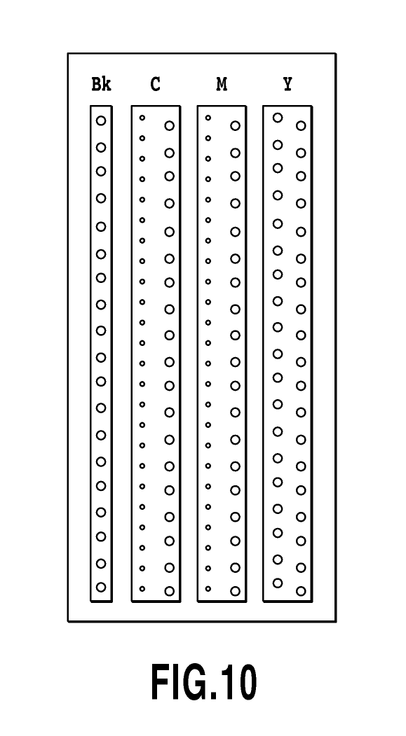

Further as shown in FIG. 10, the printing element board may be formed with a plurality of nozzle arrays with different ink ejection volumes and, if no print position misalignment occurs between these nozzle arrays, the test patterns may be printed by using only small dot nozzle arrays. This is because smaller dots are likely to have a greater effect on the dot-covered area than larger dots and therefore make density changes caused by the print position misalignment more conspicuous.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-088653, filed Apr. 7, 2010, which is hereby incorporated by reference herein in its entirety.

What is claimed is:

1. An inkjet printing apparatus to form an image on a print medium by scanning a print head having an array of printing elements relative to the print medium and ejecting ink from ejection openings of the printing elements onto the print medium to form dots thereon, the inkjet printing apparatus comprising:
a unit configured to print a predetermined pattern on the print medium by executing a first printing operation and a second printing operation by a relative scanning of the print head wherein a distance between an ejection opening-formed surface of the print head and the print medium is set at a first print head-to-medium distance and a scan speed of the print head is set at a first scan speed;
a unit configured to acquire an amount of print position misalignment between the first printing operation and the second printing operation by examining the predetermined pattern; and
a unit configured to print an image on the print medium by executing a first printing operation and a second printing operation according to a correction value obtained from the amount of print position misalignment, wherein a distance between the ejection opening-formed surface of the print head and the print medium is set at a second print head-to-medium distance larger than the first print head-to-medium distance and the scan speed of the print head is set at a second scan speed faster than the first scan speed.

2. An inkjet printing apparatus according to claim 1, wherein the relative scanning that causes the print head to eject ink onto the print medium as it moves relative to the print medium and a conveyance operation that conveys the print medium in a direction crossing the relative scanning direction are alternated repetitively to form an image on the print medium.

3. An inkjet printing apparatus according to claim 2, wherein the first printing operation is done by the print head during its forward relative scanning and the second printing operation is done by the print head during its backward relative scanning.

4. An inkjet printing apparatus according to claim 2, wherein the first printing operation is done by those of the printing elements situated at a front part of the print head with respect to the direction of the print medium conveyance operation and the second printing operation is done by those of the printing elements situated at a rear part of the print head with respect to the direction of the print medium conveyance operation.

5. An inkjet printing apparatus according to claim 1, wherein the print medium is formed with an image by the relative scanning that causes the print medium to move relative to the print head that is fixed and ejects ink at a predetermined frequency.

6. An inkjet printing apparatus according to claim 1, wherein the first printing operation is done by the print head using a predetermined ink color and the second printing operation is done by the print head using another ink color different from the predetermined ink color.

7. An inkjet printing apparatus according to claim 1, wherein the inkjet printing apparatus is able to print on a plurality of kinds of the print medium;
wherein the second head-medium distance and the second scan speed change according to the kind of the print medium.

8. An inkjet printing apparatus according to claim 1, wherein the predetermined pattern is an array of a plurality of patterns having different amounts of the misalignment between the position at which the second printing operation prints dots and the position at which the first printing operation prints dots.

9. A print position adjusting method for an inkjet printing apparatus, wherein the inkjet printing apparatus forms an image on a print medium by scanning a print head having an array of printing elements relative to the print medium and ejecting ink from ejection openings of the printing elements onto the print medium to form dots thereon, the print position adjusting method comprising:
a step for printing a predetermined pattern on the print medium by executing a first printing operation and a second printing operation by a relative scanning of the print head wherein a distance between an ejection opening-formed surface of the print head and the print medium is set at a first print head-to-medium distance and a scan speed of the print head is set at a first scan speed;
a step for acquiring an amount of print position misalignment between the first printing operation and the second printing operation by examining the predetermined pattern; and
a step for printing an image on the print medium by executing a first printing operation and a second printing operation according to a correction value obtained from the amount of print position misalignment, wherein a distance between the ejection opening-formed surface of the print head and the print medium is set at a second print head-to-medium distance larger than the first print head-to-medium distance and the scan speed of the print head is set at a second scan speed faster than the first scan speed.
